(19) United States
(12) Patent Application Publication
(10) Pub. No.: US 2017/0218977 A1
(43) Pub. Date: Aug. 3, 2017

(54) CENTRIFUGAL ELECTRIC PUMP AND MOTOR CASING FOR SUCH PUMP

(71) Applicant: DAB PUMPS S.P.A., Mestrino (IT)

(72) Inventors: Francesco SINICO, Montecchio Maggiore (IT); Pietro CAILOTTO, Trissino (IT)

(21) Appl. No.: 15/419,506

(22) Filed: Jan. 30, 2017

(30) Foreign Application Priority Data
Feb. 2, 2016 (IT) 102016000010193

(51) Int. Cl. F04D 29/58; H02K 9/19; F04D 29/42; F04D 29/62; F04D 1/00; F04D 13/06

(52) U.S. Cl. CPC F04D 29/588; F04D 1/00; F04D 13/06; F04D 29/4286; F04D 29/628; F04D 29/5806; H02K 9/19

(57) ABSTRACT

A centrifugal electric pump includes a motor casing, containing in turn, an electric motor with a transmission shaft and a hydraulic part. The transmission shaft is connected to at least one impeller present disposed in the hydraulic part. The motor casing is provided internally with a housing in which the electric motor is accommodated. An external surface of the housing defines a cooling surface adapted to be flowed over by pumping liquid that arrives from the hydraulic part. The cooling surface is provided with a covering that is resistant to oxidation. The covering is constituted by a hydraulically isolating sheath, which is contoured to affect the cooling surface.

### CROSS REFERENCE TO RELATED APPLICATIONS

This application is related to and claims the benefit of Italian Patent Application No. 102016000010193, filed on Feb. 2, 2016, the contents of which are herein incorporated by reference in their entirety.

### TECHNICAL FIELD

The present disclosure relates to a centrifugal electric pump and a motor casing for such a centrifugal electric pump.

### BACKGROUND

Conventional centrifugal pumps are composed substantially of a hollow body provided with ducts for suction and delivery, containing one or more impellers alternated with diffusers and keyed on the shaft of an electric motor enclosed in a motor casing that isolates it from the pumping liquid.

Such pumps are usually also provided with an electronic device which comprises an inverter and an electronic unit for controlling and commanding operation, typically contained in a box-like body associated with the outer side of the motor casing.

As is known, in order to ensure the correct operation and the maintenance of the best conditions of use of the pump, it is necessary that such pump be provided with a system for cooling the motor, in order to ensure the stability of the temperature by preventing it from rising beyond the intended limits

It is also necessary to control the temperature for the electronics and for the inverter.

Nowadays, in order to maintain the temperature of the motor within the design limits, cooling systems are widespread which use air and which use liquid.

In the first case, the cooling is due to a forced ventilation of air by way of a cooling fan installed in the motor casing.

In the second case, the motor casing is flowed over by at least a fraction of the liquid moved by the hydraulic part, in order to then ascend to the delivery duct.

The electronic device is also cooled by a special cooling fan, or by way of the same liquid that flows over the motor casing with which the device is associated.

Liquid cooling is preferable in particular for surface pumps, where the need is better felt to reduce the noise of pumping devices, by eliminating the external cooling fan.

However this system is not devoid of drawbacks, the foremost drawback being the need to make the motor casing of stainless steel, in order to protect it from oxidation due to the passage of liquid, typically the pumping water.

Although metallic materials in general lend themselves well to conducting heat, stainless steel does not give optimal results in cooling the motor.

Furthermore, their use requires onerous methods of production, such as for example, casting in sand, and its contribution to the weight of the pump is not insignificant.

It is more common to make motor casings from stainless steel by way of cold pressing by drawing of sheet metal or by way of deformation by calendering.

These production processes, however, also have some drawbacks, the foremost drawback being control of the geometric and dimensional tolerances of the product.

To this is added the drawback, as with the casting process, of not inconsiderable production costs.

In order to overcome these drawbacks, a centrifugal electric pump has been developed in which the motor casing is made of aluminum and has a cooling surface flowed over by pumping liquid originating from the hydraulic part.

The cooling surface is advantageously provided with a covering that is resistant to oxidation.

Such covering is provided by depositing materials that are resistant to oxidation, for example by tefloning, or by depositing ceramic material or by over-molding plastic material. The plastic material includes, for example, an elastomeric rubber with high thermal conductivity, which is anchored to the motor casing by hot vulcanization.

Such covering, although functional, has been found to be relatively complex to provide, since the deposition or over-molding operations affect a complex surface of the motor casing, and one that is internal to such motor casing, and therefore difficult to reach both in order to carry out such operations and in order to check the work carried out.

### SUMMARY

The aim of the present disclosure is to provide a centrifugal electric pump that is capable of ensuring the right level of cooling of the motor in the absence of a cooling fan and which can be produced at low cost.

Within this aim, the disclosure provides an electric pump in which the motor casing is covered simply and equally effectively.

The disclosure also provides an electric pump with a motor casing that is lighter than conventional casings, thus ensuring an overall greater lightness for the entire centrifugal pump.

The disclosure further provides an electric pump while ensuring a good control of the geometric and dimensional tolerances of the finished product.

This aim and these and other advantages which will become better evident hereinafter are achieved by providing a centrifugal electric pump comprising a motor casing, containing an electric motor with a transmission shaft, and a hydraulic part, the transmission shaft being connected to at least one impeller present in the hydraulic part, the motor casing being provided internally with a housing in which the electric motor is accommodated, an external surface of the housing defining a cooling surface, adapted to be flowed over by pumping liquid that arrives from the hydraulic part, the cooling surface being provided with a covering that is resistant to oxidation, wherein the covering is constituted by a hydraulically isolating sheath, which is contoured to affect the cooling surface, and by a motor casing wherein the sheath is inserted into the casing in a removable manner.

### BRIEF DESCRIPTION OF THE DRAWINGS

Further characteristics and advantages of the disclosure will become better apparent from the detailed description that follows of a preferred, but not exclusive, embodiment of the centrifugal electric pump according to the disclosure, which is illustrated for the purposes of non-limiting example in the accompanying drawings wherein:

FIG. 1 is a cross-sectional side view of a centrifugal electric pump according to the disclosure;

FIG. 2 is a cross-sectional, partially exploded plan view of the electric pump according to the disclosure;

FIG. 3 is a cutaway perspective view of a pump body with covering, partially assembled; and

FIG. 4 is a cutaway perspective view of the pump body of FIG. 3 with covering, assembled.

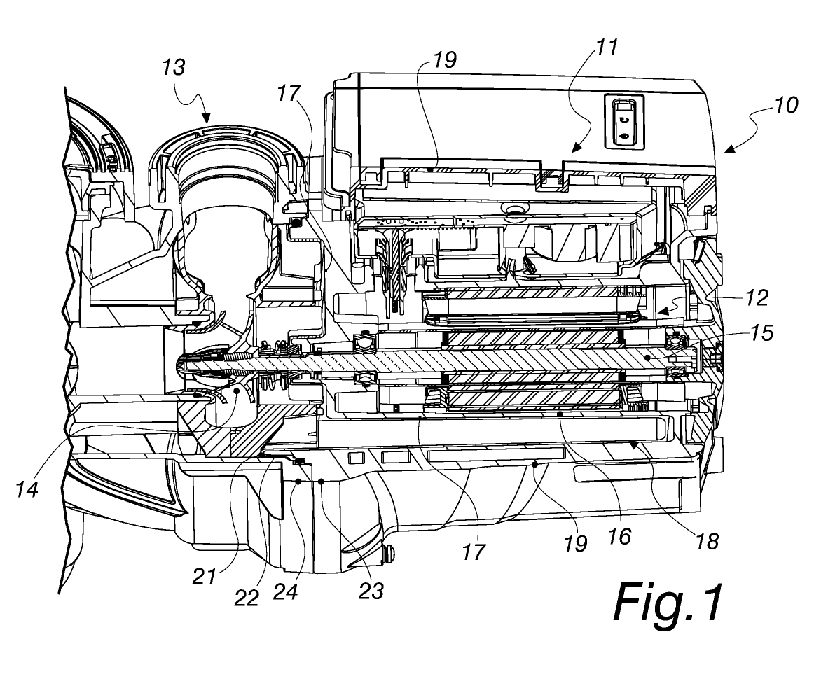

### DETAILED DESCRIPTION OF THE DRAWINGS

With reference to the figures, a centrifugal electric pump according to the disclosure is generally designated with the reference numeral 10.

The centrifugal electric pump 10 comprises a motor casing 11, which in turn contains an electric motor 12 with a transmission shaft 15, and a hydraulic part 13.

The transmission shaft 15 is connected to an impeller 14 which is in the hydraulic part 13.

The motor casing 11 is provided internally with a housing 16 inside which the electric motor 12 is arranged.

The external surface of the housing 16 provides a cooling surface 17, which is adapted to be flowed over by the pumping liquid originating from the hydraulic part 13.

The cooling surface 17 is provided with a covering that is resistant to oxidation.

The covering is constituted by a hydraulically isolating sheath 18, which is contoured to affect the cooling surface 17.

The sheath 18 is made of plastic material, and therefore can be provided by molding, for example by injection molding or by compression molding.

The sheath 18 is made of elastomeric material, and preferably of rubber.

Elastomeric rubber has good mechanical properties, since it can have a good value of load on breakage, of resistance to permanent deformation, and of elastic recovery, and a good resistance to fatigue, to tearing and to wear, plus it is non-toxic and therefore lends itself well to be flowed over by water without releasing pollutants.

The motor casing 11 is made of aluminum.

The motor casing 11 can be provided by casting or, preferably, by high-pressure die casting of aluminum; subsequently the motor casing 11 is mechanically machined.

The motor casing 11 comprises an outer enclosure 19 and the internal housing 16, which are integrated in a single piece of aluminum

Between the housing 16 and the inner surface of the housing 19, an interspace 20 is defined for the circulation of the pumped cooling liquid.

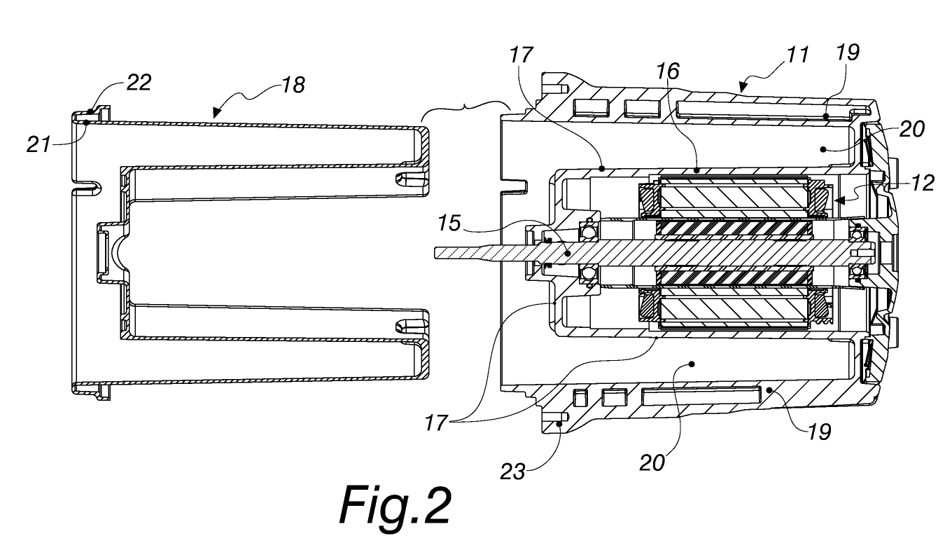

The hydraulically isolating sheath 18, contoured to affect the cooling surface 17, is therefore contoured to cover both the housing 16 and the inner surface of the housing 19 which cooperates to define the interspace 20, as can clearly be seen in FIGS. 2, 3 and 4, thus protecting both the housing 16 and the enclosure 19.

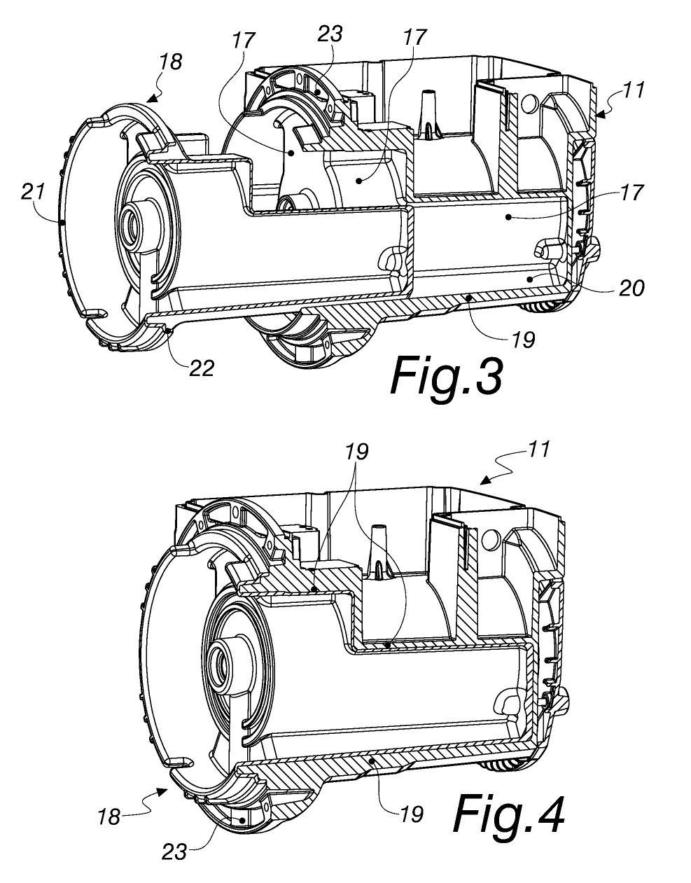

It can clearly be seen in FIG. 3 that the sheath 18 is a separate component, made by molding and then assembled with the motor casing 11.

The sheath 18 has a perimetric edge 21 with a fold 22 that is designed to be locked by pinching between the join flanges 23 and 24 respectively of the motor casing 11 and of the hydraulic part 13.

In a first variation of embodiment of the disclosure, the sheath 18 is inserted into the motor casing 11 in a removable manner, and is therefore free to be removed if the necessity arises.

In a second variation of embodiment of the disclosure, the sheath 18 is inserted into the motor casing 11 and is glued therein.

The sheath 18, if not glued, in addition to being rapidly assemblable, is also equally rapidly removable for substitution or for the separate disposal of the components of the electric pump at end of life.

The centrifugal electric pump 10 according to the disclosure therefore has the electric motor 12, synchronous with permanent magnets or traditional asynchronous, cooled by the pumped liquid.

Such an electric pump 10 comprises the above mentioned components which contribute to achieving the principal aim, i.e. the saving of energy with respect to conventional traditional pumps.

The pump 10 also brings other important advantages, such as a reduction of noise and contained encumbrances with respect to similar electric pumps on the market today.

In particular, the reduction of noise is due to the fact that there is no rear fan used to cool the motor, given that the motor is particularly efficient and cooled by the pumped liquid.

In particular the electric motor 12 is cooled by the pumped liquid (in this case water) by virtue of the removal of heat achieved through the cooling surface 17 and by virtue of the overlying sheath 18 and the rear fan used to cool the motor has been eliminated. The motor casing is made of aluminum lined with rubber in order to protect it from oxidation in the parts in contact with water.

The disclosure also relates to a motor casing 11 as described above, containing an electric motor 12; the motor casing 11 is provided internally with a housing 16 in which the electric motor 12 is accommodated, the external surface of the housing 16 defining a cooling surface 17 which is adapted to be flowed over by pumping liquid originating from a hydraulic part 13 of an electric pump of which the motor casing 11 is part.

The cooling surface 17 is provided with a covering that is resistant to oxidation.

The motor casing 11 is characterized in that the covering is constituted by a hydraulically isolating sheath 18, which is contoured to affect the cooling surface 17, as described above.

In practice it has been found that the disclosure fully achieves the intended aim and objects.

In particular, with the disclosure a centrifugal electric pump has been devised that is capable of ensuring the right level of cooling of the motor in the absence of a cooling fan, and which can be produced at low cost.

Furthermore, with the disclosure an electric pump has been devised the aluminum motor casing of which is covered simply and equally effectively in terms of isolation from water and therefore of protection from oxidation.

What is more, with the disclosure an electric pump has been devised with a motor casing made of aluminum, therefore lighter than conventional casings, thus ensuring an overall greater lightness for the entire centrifugal pump.

What is more, with the disclosure an electric pump has been provided in which a good control is ensured of the geometric and dimensional tolerances of the aluminum components in the finished product.

The disclosure, thus conceived, is susceptible of numerous modifications and variations. Moreover, all the details may be substituted by other, technically equivalent elements.

In practice the components and the materials employed, provided they are compatible with the specific use, and the contingent dimensions and shapes, may be any according to requirements and to the state of the art.

1. A centrifugal electric pump comprising a motor casing, containing an electric motor with a transmission shaft, and a hydraulic part, the transmission shaft being connected to at least one impeller disposed in said hydraulic part, said motor casing being provided internally with a housing in which said electric motor is accommodated, an external surface of said housing defining a cooling surface, adapted to be flowed over by pumping liquid that arrives from said hydraulic part, said cooling surface being provided with a covering that is resistant to oxidation, wherein said covering is constituted by a hydraulically isolating sheath contoured to affect said cooling surface.

2. The electric pump according to claim 1, wherein said sheath is made of plastic material.

3. The electric pump according to claim 1, wherein said sheath is made of elastomeric material.

4. The electric pump according to claim 1, wherein said sheath is inserted into the motor casing in a removable manner.

5. The electric pump according to claim 1, wherein said sheath is glued inside the motor casing.

6. A motor casing, containing an electric motor, said motor casing having a housing disposed therein in which said electric motor is accommodated, the external surface of said housing defining a cooling surface adapted to be flowed over by pumping liquid, said cooling surface being provided with a covering that is resistant to oxidation, wherein said covering is constituted by a hydraulically isolating sheath contoured to affect said cooling surface.
